(19) United States
(12) Patent Application Publication
(10) Pub. No.: US 2022/0074963 A1
(43) Pub. Date: Mar. 10, 2022

(54) A SENSOR DEVICE FOR MONITORING STRUCTURAL ELEMENTS, A CLAMPING ELEMENT, AN EXAMINATION UNIT AND A METHOD FOR CONSTRUCTING SAID SENSOR DEVICE

(71) Applicant: SAFECERTIFIEDSTRUCTURE TECNOLOGIA S.R.L., Roma (IT)

(72) Inventor: Giuseppe MANCINI, TORINO (IT)

(73) Assignee: SAFECERTIFIEDSTRUCTURE TECNOLOGIA S.R.L., Roma (IT)

(21) Appl. No.: 17/415,831

(22) PCT Filed: Dec. 11, 2019
(86) PCT No.: PCT/IB2019/060648

§ 371 Date: Jun. 18, 2021

(30) Foreign Application Priority Data
Dec. 21, 2018 (IT) 102018000020959

(51) Int. Cl. G01P 1/02; G01P 15/00; G01C 9/02

(52) U.S. Cl. CPC G01P 1/023; G01C 9/02; G01P 15/00

(57) ABSTRACT

Sensor device (1) for monitoring structural elements, comprising a container (4), which is preferably box-shaped and has a first elastic modulus (E1), a processing device (11), which is housed inside the container (4) and comprises a processing unit (11a), a support (12) on which the processing unit (11a) is installed, at least one inclinometer (3) and/or one accelerometer (15), which is/are housed on the support (12) and operatively connected to the processing unit (11a), the support (12) being secured to the container (4) by means of a fixing element (12a) having a second elastic modulus (E2) that is greater than or equal to the first elastic modulus (E1).

### TECHNICAL FIELD

The invention relates to a sensor device for monitoring structural elements, to a clamping system, to an examination unit and to an associated production method, having the features mentioned in the preamble of the independent claims.

### TECHNOLOGICAL BACKGROUND

It is known that artificial structural elements (for example bridge portions, walls of houses, etc.) or natural structural elements (portions of land, portions of water basins, portions of blankets of snow, etc.) can suffer rotations associated with displacement and/or deformation if they themselves are subjected to movements or failure or if other structural portions or other portions of the ground to which they are directly or indirectly connected are subjected to movements or failure (e.g. landslides, earthquakes, settlements, etc.).

In particular, these movements or failure of the ground can develop both unpredictably and very rapidly, thereby causing damage, even catastrophic damage, to structures or portions of land that are directly or indirectly affected by the above-mentioned movements or failure.

The need to be able to effectively monitor the development of the above-mentioned movements and/or failure of these structural portions and, if necessary, to be promptly updated with respect thereto is therefore obvious.

Within the context of this need for information and monitoring, a relevant document is Chinese patent application CN 105973200, which describes an automated portable inclinometer for monitoring landslides, comprising a sensor that is housed on a rigid slide that slides on a track of a tube inserted inside a piece of land to be examined, a cable connected to the sensor at one end and to means for withdrawing said cable at the other end, and a system for processing the data collected.

When necessary, an operator has to go to the piece of land in which the tube has been arranged beforehand, insert the above-mentioned automatic inclinometer into said piece of land and slowly make it slide in the vertical direction with respect to the piece of land so as to collect the various information provided by the sensor on the basis of the analysed depth at which the sensor is positioned.

This product is, however, unsuitable for continuously and effectively monitoring structural elements (in this specific case, these are considered to be portions of land that are liable to potential landslides, but the same reasoning applies to lift shafts, portions of bridges, etc.).

First of all, a clear drawback of the products formed according to the teaching of the prior art is that the desired sensor is not stably and effectively inserted into the tube or the building portion or the bridge portion under examination. In fact, for example the rigid slide by means of which the sensor moves represents a portion that is much smaller than the typical dimensions of the zone under examination of the tubes inserted into the pieces of land, which pieces of land may potentially be affected by landslides (generally of lengths between 100 and 200 metres). Of course, during or following possible landslides, the tubes inserted into the pieces of land under examination may also suffer severe deformation following different sliding movements of specific portions of land having a different composition or behaviour. It is immediately clear that, in these cases, the solution described by the above-mentioned Chinese patent may be ineffective, if not even completely useless, since there is a risk of the rigid slide not even being able to pass through the tube under examination or only being able to pass through a limited portion of the tube. Another disadvantage in this example relates to the inability to monitor the structure concerned potentially immediately and constantly (in real time).

Still taking the above-mentioned Chinese document into consideration, another critical disadvantage is represented by the fact that, in order to be able to promptly intervene in the aforementioned case, it must be possible to collect the data of interest in the smallest amount of time possible. It is clear that the technical solution analyzed provides that the operator goes to the piece of land under examination, or more generally the structure under examination (which may also be difficult to get to quickly with everyday means), inserts the rigid slide into the tube under examination (provided this is still possible, as discussed previously), and collects the data on-site.

These operations can cause intervention delays that can be quantified in terms of hours (in the more fortunate cases) and several days (in the less fortunate cases).

Furthermore, it is appropriate to consider that, if the landslide has also compromised the access routes to the piece of land of interest, the examination will be impossible. The same considerations apply to collapsed bride portions or to damaged portions of buildings.

In general, the disadvantage that the prior art demonstrates is therefore a requirement relating to the average life of the sensor apparatus exposed to atmospheric agents, to freeze/thaw cycles, to potential salt deposits when in the proximity of coastal zones, to collisions with moving objects, etc., which life is often shortened to too great an extent, thus risking rapidly compromising the quality and the accuracy of the data recorded.

### DESCRIPTION OF THE INVENTION

The object of the present invention is to provide a sensor device for monitoring structural elements, a clamping system, an examination unit and a production method associated therewith, which overcome one or more of the drawbacks of the identified prior art at least in part.

In this context, “structural elements” means those portions of artificial structures (for example bridge portions, walls of houses, lift shafts, etc.) or natural structures (portions of land, portions of water basins, portions of blankets of snow, etc.) that can suffer rotations, displacement and/or deformation if subjected to movements or failure of the ground (e.g. landslides, earthquakes, settlements, etc.) to which they are directly or indirectly connected.

Within this scope, one object of the invention is to produce a sensor device that can be easily transported to the site of interest and can be easily installed in or on said site.

Furthermore, one object of the invention is to produce a sensor device that has a greater average life even when exposed to atmospheric agents, while maintaining the quality with which the desired signals are detected.

The invention formed according to the present invention is a sensor device for monitoring structural elements, comprising a container, which is preferably box-shaped and has a first elastic modulus, and a processing device housed inside the container.

The processing device preferably comprises a processing unit, a support on which the processing unit is installed, and at least one inclinometer and/or one accelerometer which is/are housed on the support and operatively connected to the processing unit.

According to one embodiment, the support is secured to the container by means of a fixing element having a second elastic modulus that is greater than or equal to the first elastic modulus.

The applicant has verified that, on account of this technical solution, it is possible to prevent the sensor device from becoming excessively damaged by the external environmental or artificial elements.

Furthermore, the degree of accuracy of the reading made by the at least on inclinometer and/or one accelerometer results from the insertion of the fixing element, which has an elastic modulus (and therefore more rigid behaviour), into the container. In this way, the deformation of the local point is accurately transferred to the inside of the container.

The applicant carried out an in-depth study in order to identify the best solutions in relation to the features of the container and of the fixing element.

Purely by way of non-limiting example, the container is preferably made of polycarbonate and the fixing element is a two-component resin.

According to one embodiment, the support is a printed circuit board or the like, and the processing unit and the at least one inclinometer and/or the accelerometer are housed on the opposite side of the support to the fixing element.

In this way, the sensing elements and their necessary connections are ideally arranged, thus guaranteeing direct and effective detection of any displacement and/or deformation.

The container preferably comprises a seat that is delimited by a bead, and the fixing element is exclusively positioned inside the seat.

In this way, it is possible to position the fixing element, advantageously the two-component resin still in liquid phase, in the seat and to thereby secure the printed circuit board to the container in an effective manner, while leaving a lower portion of the printed circuit board that is not covered by the resin and is therefore accessible for the subsequent installation of a further sensor/transducer (for example a microphone for analyzing specific frequency patterns).

According to one embodiment, the sensor device comprises a first cable that is operatively connected to the processing unit and passes through the container via a first hole that is made in said container, the container comprising an inlet hole and an outlet hole that are designed so as to allow a filler material, preferably a hydrophobic filler material, to be inserted by injecting it through the inlet hole, the container to be filled with the filler material and said filler material to be consequently discharged out of the outlet hole.

These features make it possible to perform the filling step in the best possible manner, thereby allowing the air present in the container to escape via the outlet hole while the fixing element is inserted into the entrance hole.

In this way, a sensor device is formed that also guarantees a degree of resistance to a water column that is equal to 5-6 bars for more than 200 hours. This condition renders it certifiable as IP68 and higher protocols.

The filler material is advantageously a thermosetting resin, preferably a two-component thermosetting resin.

This facilitates the insertion, preferably by means of injection systems, of the filler material, which has a lower viscosity and is still in a pre-crosslinked phase, which makes it possible to fill the container, thereby avoiding the presence of macroscopic air bubbles and shadow cones during filling.

According to one embodiment, the inlet hole and the outlet hole are made in a same second wall of the container, which second wall is preferably opposite a first wall on which the support is secured to the container.

On account of this technical solution, the process of inserting the fixing element is optimized at the same time as the process of removing the air by means of simplified access to and arrangement of the equipment intended for these operations.

According to one embodiment, the container comprises at least one protrusion, which preferably projects from the first and/or second wall towards the outside of the container.

This optimizes and facilitates the process of securing the sensor device to structures provided for receiving it by means of interference-type engagement, as well as to said protrusion.

According to one embodiment, the sensor device comprises a magnetometer such that an initial orientation of the at least one inclinometer and/or one accelerometer can be defined in order to detect relative movements.

In this way, it is possible to have an even more accurate reading of the changes in the orientation of the inclinometers proceeding from a known initial orientation. Furthermore, the presence of an accelerometer makes it possible to expand the information relating to the movements of the inclinometer or parts associated therewith.

Preferably, the sensor device comprises at least one GPS and/or one humidity sensor and/or one temperature sensor.

In this way, it is possible to further improve the information that is obtainable by the sensor device, since the GPS will make it possible to link the inclinations on the basis of specific spatial coordinates and will therefore make it possible to understand which structural portion under examination is effectively subjected to rotation.

Furthermore, the presence of the GPS makes it possible to identify false negatives that may be created in situations in which the entire structure shifts in a purely translational manner without demonstrating significant local rotations.

Still, the presence of humidity and temperature sensors makes it possible to monitor the conditions in which the data readings are made and to therefore possibly correct said data, if need be.

According to other embodiments that are also covered by the present invention, a system for clamping sensors for structural elements is described, comprising a sensor device that is formed according to any one of the preceding claims, a clamping bracket comprising at least one hole that is designed to receive at least one of the protrusions of the sensor device by means of interference-type engagement.

According to other embodiments that are also covered by the present invention, a unit is described for examining structural elements, comprising a sensor device having at least one of the previously described features, and a flexible tape having at least one hole that is designed to receive at least one of the protrusions by means of interference-type engagement.

In this way, the examination unit can be easily rolled up on itself in order to increase the transportability thereof, and can be unwound once it has reached the point of interest in order to be easily installed.

Furthermore, on account of the above-mentioned technical features, the above-mentioned examination unit allows for permanent installation in or on the site of interest, it being left there in order to provide, potentially continuously, up-to-date data relating to possible rotations associated with displacement and/or deformation or failure of the examination unit itself or of other structural portions or other portions of the ground to which said structural portions are directly or indirectly connected.

The above-mentioned examination unit can therefore be effectively applied, for example, to the inside of holes in a piece of land in order to evaluate the movements of portions thereof in the event of possible landslides, to bays of bridges in order to evaluate structural changes or failure following the transit of the vehicles and the wear or movements of portions of land directly or indirectly linked to the above-mentioned structures, to ashlars of a tunnel (in both the longitudinal and transverse direction with respect to the direction of extension of the tunnel itself) in order to evaluate the stability and hold of the structure, to structural portions of dams in order to evaluate any structural changes or failure in this case, too, which may be associated with displacement or failure of portions of land directly or indirectly linked to the above-mentioned structures, etc.

According to one embodiment, the at least one inclinometer is housed on or in the flexible tape, i.e. this implies that the above-mentioned inclinometer can be secured so as to rest against a surface of the tape or can be inserted inside the tape itself (e.g. the tape comprises two surfaces that wrap around or encompass the device, or the device is housed inside a cavity made in the above-mentioned tape, etc.).

The examination unit preferably comprises a plurality of inclinometers and the tape comprises a cable that operatively connects at least two inclinometers of a plurality of inclinometers.

In this way, the ability of the examination unit to collect data is improved by inserting a plurality of inclinometers and/or accelerometers connected by means of a cable that makes it possible to transfer data between the inclinometers and/or accelerometers and to transfer electrical power in order to supply the above-mentioned inclinometers and/or accelerometers with power.

According to one embodiment, the examination unit comprises a processing unit that is operatively connected to the at least one inclinometer and/or accelerometer in order to process the data collected by the at least one inclinometer.

This makes it possible to ensure that the data collected by the at least one inclinometer is processed at said site of interest, thus optimizing the processing time and therefore reducing the time required to be able to access and/or make use of the above-mentioned data that is processed by a user.

The processing unit is preferably operatively connected to the at least one inclinometer by means of the cable at a second end of the tape that is opposite a first end.

This optimises both the usability and movements of the flexible tape during the steps of transportation, installation and/or connection, and the accessibility of the processing unit to a user.

According to one embodiment, the plurality of inclinometers and/or accelerometers are spaced apart by a pitch along a first longitudinal axis of the tape.

In this way, the site of interest is monitored more effectively since the plurality of inclinometers are positioned at a known distance and optimized on the basis of what they intend to monitor.

The above-mentioned pitch can advantageously be constant or variable along the above-mentioned first longitudinal axis.

The above-mentioned container is preferably watertight on account of the hydrophobic filler material inserted therein. In this way, the examination unit meets the requirements in respect of water resistance up to 5-6 bars of a water column applied for more than 200 hours. This examination unit is therefore certifiable as IP68.

On account of this technical solution, it is possible for the examination unit to be permanently secured in the site of interest, while guaranteeing that the electrical and/or electronic components contained therein are not damaged by the natural agents that are present (e.g. rain, wind, exposure to sun or frost, high level of relative humidity, etc.).

According to one embodiment, the examination unit comprises a protective heat-shrink casing that is watertight and wrapped at least in part around the flexible tape and the at least one sensor device.

This casing makes it possible to stack and transport the examination unit more securely, thereby preventing unwanted elements from coming into contact with the electronic parts of the above-mentioned device.

One embodiment of the present invention according to the above-mentioned invention provides a monitoring system, which comprises an examination unit comprising a flexible tape, at least one inclinometer that is housed on or in the tape, the tape having a main extension along a first longitudinal axis and a width that is perpendicular to the first longitudinal axis, and a tube that has a second longitudinal axis and comprises an opening designed to allow the free sliding motion of the tape inside the tube in the direction of the second longitudinal axis.

In this way, it is possible to further optimize the insertion of the monitoring system into a site of interest by inserting the flexible tape into a tube that has been pre-positioned inside a hole made in a piece of land under examination, for example.

The opening is preferably substantially circular, having a diameter that is greater than or equal to the width of the tape so as to allow for the free sliding motion of the tape inside the tube in the direction of the second longitudinal axis.

This facilitates and speeds up the action of inserting the tape into the tube.

According to one embodiment, the tape has a thickness and the tube comprises at least one guide rail for the tape, which rail extends along the second longitudinal axis, since the guide rail has a width that is greater than or equal to the thickness of the tape so as to allow the tape to slide in a guided manner along the second longitudinal axis.

Preferably, the tape has a width, the tube comprises at least one guide rail for the tape, which rail extends along the second longitudinal axis, and the guide rail has a width that is greater than or equal to the thickness of the tape so as to allow the tape to slide in a guided manner along the second longitudinal axis.

The guide rail is preferably defined by grooves formed in an internal wall of the tube or by protrusions that project from the internal wall of the tube.

In this way, it is possible to secure the flexible tape to the inside of the tube along directions that are perpendicular to the first longitudinal axis.

One embodiment of the present invention provides a method for monitoring structural elements, comprising making a hole in a piece of land to be monitored, inserting an examination unit which has the previously described features into the hole at a predefined height, securing the examination unit in the hole such that it cannot be removed, connecting a second end of the tape of the examination unit to a processing unit, and measuring the initial orientation of the at least one inclinometer.

In this way, the examination unit is effectively installed inside a piece of land to be monitored.

This type of installation makes it possible to constantly provide useful data at a desired frequency, therefore making it possible to identify a trend within the data over time and sudden potentially critical changes in near real-time.

Furthermore, one embodiment of the above-mentioned method provides irremovably securing the examination unit in the hole by injecting grout into the hole.

This makes it possible to rigidly and integrally secure the examination unit to portions of the grout that are in turn associated with the rotations and/or displacements of portions of the ground.

According to one embodiment, the method provides inserting a tube into the hole in the ground to be monitored, inserting an examination unit into the tube at a predefined height, irremovably securing the examination unit in the hole by injecting grout into the tube, connecting a second end of the tape of the examination unit to a processing unit, and measuring the orientation of the at least one inclinometer.

This makes the step of inserting the examination unit into the ground even more reliable as a result of the presence of a tube that more stably defines the internal cavity of the hole inside which the examination unit is inserted.

According to one embodiment, the method comprises progressively removing the tube from the hole during the step of injecting grout into the tube.

This saves on the material used and the grout comes into direct contact with the ground portions to be monitored.

The method preferably comprises measuring the orientation of the at least one inclinometer after the grout has aged for a predetermined amount of time.

In this way, any inclinations that may develop following the aging process of the grout can be monitored.

According to one embodiment, the method comprises monitoring the trend relating to the orientation over time using a processing unit.

In this way, it is possible to constantly monitor the orientation and to quickly detect any significant changes from the intended or desired orientation.

### DESCRIPTION OF THE DRAWINGS

The features and advantages of the invention will become clearer from the detailed description of one embodiment, which is illustrated by way of non-limiting example, and with reference to the attached drawings, in which:

FIG. 1 is a perspective view of a sensor device for monitoring structural elements,

FIG. 2 is a schematic view of a cross section of the sensor device in FIG. 1 along a plane I,

FIG. 3 is a schematic view of said cross section of the sensor device in FIG. 2, comprising filler material,

FIG. 4 is a schematic view of a cross section of an examination unit comprising a flexible tape and the sensor device in FIG. 1, again along the plane I,

FIG. 5 is a perspective view of a clamping system comprising the sensor device in FIG. 1, a clamping bracket to which the device is secured and a beam portion (for example of an additional structural element).

### DETAILED DESCRIPTION OF ONE EMBODIMENT

In the figures, reference numeral 1 represents a sensor device that is formed in accordance with the present invention and is intended for installation in or on a site of interest.

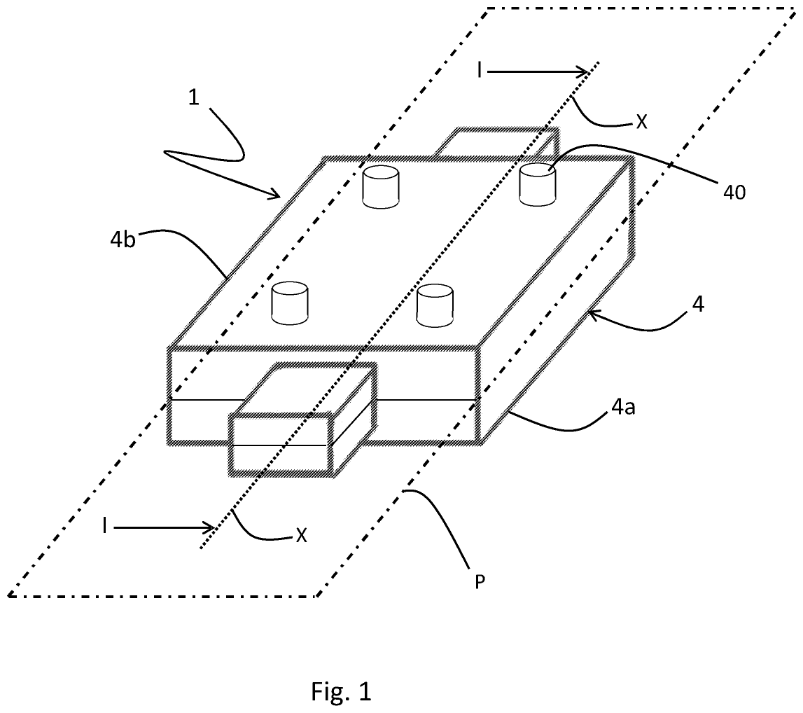

Preferably and with reference to FIG. 1, the sensor device 1 for monitoring structural elements comprises a container 4, which is preferably box-shaped and has a first elastic modulus E1, and a processing device 11 that is housed inside the container 4.

In this context, the first elastic modulus E1 corresponds to the elastic modulus of the material from which the container 4 is made.

As can be seen from FIG. 1, 2 or 3 and according to a preferred embodiment, the container 4 is box-shaped, i.e. parallelepiped-shaped, having a main extension along the direction of a longitudinal axis X. As is known, this structure has six faces, including a first and a second base or larger walls 4a, 4b. Preferably and with reference to FIG. 1, the first wall 4a is the largest wall intended to come into contact with a surface of the structural element under analysis, while the second wall 4b is the opposite wall 4b with respect to said longitudinal axis X.

According to alternative embodiments of the present invention, the box shape may be substituted with semi-globular shapes or the like, thereby ensuring that the first wall 4a is shaped so as to be able to uniformly come into contact with the surface of the structural element that is under analysis.

According to one embodiment, the processing device 11 comprises a processing unit 11a, a support 12 on which the processing unit 11a is installed, and at least one inclinometer 3 and/or one accelerometer 15 that is/are housed on the support and operatively connected to the processing unit 11a. The support 12 is advantageously secured to the container 4 by means of a fixing element 12a having a second elastic modulus E2 that is equal to or greater than the first elastic modulus E1.

According to one embodiment, the sensor device 1 comprises at least one GPS 16 and/or one humidity sensor 17 and/or one temperature sensor 18.

The above-mentioned GPS, humidity sensor 17 and temperature sensor 18 will be clearly identifiable by a person skilled in the art according to specific needs.

According to one embodiment, the container 4 is made of a polymeric material, preferably a thermoplastics material and more preferably of polycarbonate.

The fixing element 12a is advantageously a thermosetting resin, preferably a two-component resin. A value for the first elastic modulus E1, cited by way of non-limiting example, is between 1000 N/mm² (or 1 GPa) and 5000 N/mm² (8 GPa), more preferably approximately 2000 N/mm².

Preferably, the second elastic modulus E2 is always greater than the first elastic modulus E1 and equal to a value in the range of between 1,500 N/mm² and 8000 N/mm². When using a thermosetting material, the value for the second elastic modulus E2 specified previously relates to the completion of the crosslinking process.

The fixing element 12a is advantageously a thermosetting two-component epoxy-based resin, which may be loaded with glass, carbon or graphene fibres of the type of product Scotch-Weld DP490.

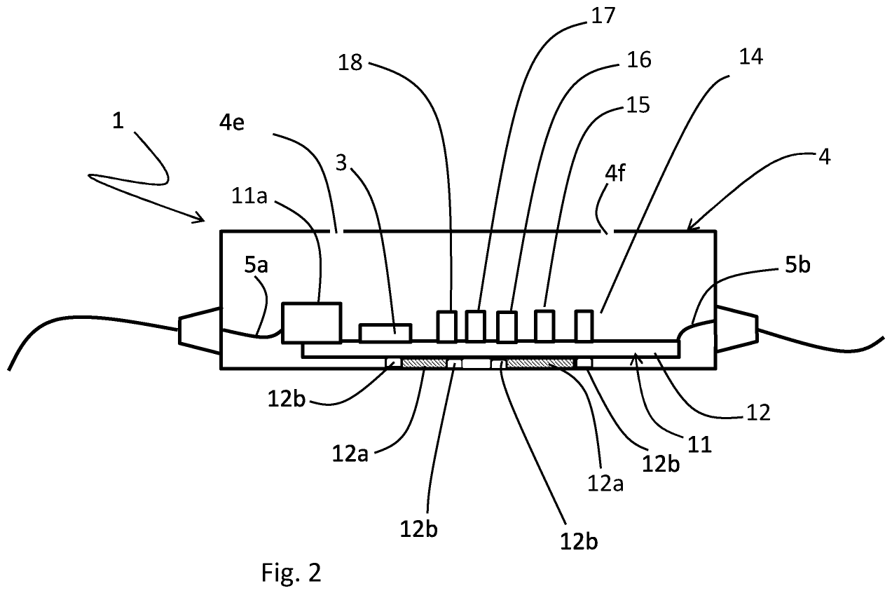

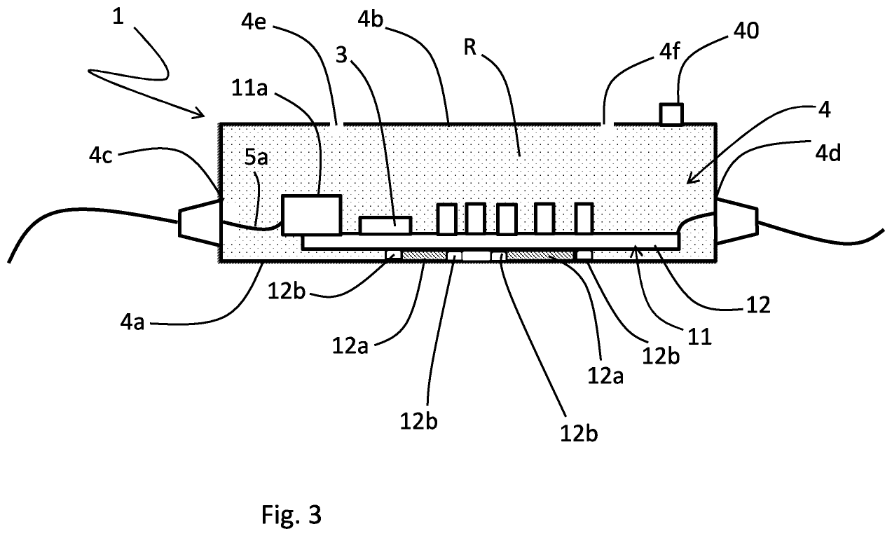

According to an embodiment shown in FIGS. 2 and 3, the support 12 is a printed circuit board, and the processing unit 11a and the at least one inclinometer 3 and/or the accelerometer 15 are housed on the opposite side of the support 12 to the fixing element 12a.

The processing unit 11a is preferably a CPU (e.g. a processor, server, etc.) that can recognize the data provided by the at least one inclinometer, process it and transfer it to additional processing units via appropriate means for transferring data. The CPU is preferably operatively connected to a data bus such that more than one inclinometer can be connected thereto and such that each inclinometer is connected in parallel so as not to compromise the functionality of the sensor device if one inclinometer is damaged.

The data-transfer means are preferably provided for making transfers via Wi-Fi systems, Bluetooth systems, Cloud systems, etc.

If present, the at least one inclinometer 3 is preferably uniaxial, biaxial or triaxial. If present, the accelerometer 15 is advantageously also uniaxial, biaxial or triaxial.

With reference to FIG. 2, it is clear how the at least one inclinometer 3 and/or the accelerometer 15 are housed on the opposite side of the support 12 to the fixing element 12a, and how said fixing element is near to the at least one inclinometer 3 and/or the accelerometer 15 that is at a distance from the wall of the container 4.

According to one embodiment and with reference to FIGS. 2 and 3, the container 4 comprises a seat 13 that is delimited by a bead 12b, and in which the fixing element 12a is positioned exclusively inside the seat 13. The seat 13 is advantageously formed in the internal portion of the first wall 4a and is substantially “annular or doughnut-shaped” so as to provide a central zone that cannot be reached by the fixing element 12a when said fixing element is used in the form of a thermosetting polymeric resin and is initially poured in in a semi-liquid state and then a crosslinking state. In this way, the central zone is free to be subsequently removed to allow the correct function of additional sensors (e.g. a microphone).

Preferably and with reference once again to FIGS. 2 and 3, the sensor device 1 comprises a first cable 5a that is operatively connected to the processing unit 11a and passes through the container 4 via a first hole 4c that is made therein. Furthermore, the container 4 comprises an inlet hole 4e and an outlet hole 4f that are designed to allow
a filler material R, preferably a hydrophobic filler material, to be inserted by injecting it through the inlet hole 4e,
the container 4 to be filled with the filler material R and the filler material to consequently be discharged out of the outlet hole 4f.

Since the container 4 is preferably made of polycarbonate, the applicant has proven that this solution makes it possible to carry out an injection process under a pressure in the range of between 1 and 6 bars.

Furthermore, the provision of the outlet hole 4f allows the air present inside the container 4 to be effectively discharged, leaving just one sensor device in which all the elements are integrally secured to one another.

It is obvious that, on the basis of the selected processes, the expert in the field will assess whether to position the processing unit 11a and the cable 5a inside the container 4, for example, to close it by means of localized fusing/welding, for example, joining two half-shells respectively comprising the first wall 4a and the second wall 4b.

Furthermore, should a type of series connection be more desirable, FIGS. 2 and 3 show a second cable 5b that is operatively connected to the processing unit 11a and leaves the container 4 via a second hole 4d.

The filler material R is preferably a thermosetting resin, preferably a two-component thermosetting resin.

According to one embodiment, this thermosetting two-component resin of the filler material R can be an epoxy-based hydrophobic resin that may be loaded with fibres.

In particular, the applicant has observed that such a technical solution makes it possible to effectively fill the container 4 and to secure and seal the various internal parts, making it able to resist a water column that is applied and is equivalent to pressures of approximately 8 bars.

This technical solution is particularly interesting, since it makes it possible to provide sensor devices 1 that are able to have a rate of H₂O absorption equal to 0.1-0.9% of the standardised test ASTM D570, and to therefore be classifiable as IP68.

The filler material R preferably has an elastic modulus of between 1 GPa and 10 GPa, more preferably between 5 GPa and 6 GPa.

Examples of this filler material are Elan-tron MC28/W228.

This technical solution also makes it possible to use the examination device 1 underground or in positions in which higher levels of relative humidity are possible (for example a pit of a lift shaft).

According to one embodiment and shown in FIGS. 2 and 3, the inlet hole 4e and the outlet hole 4f are made in a same second wall 4b of the container 4, preferably opposite the first wall 4a on which the support 12 is secured to the container 4. These inlet and outlet holes advantageously have a diameter of between 0.1 and 0.9 mm.

According to one embodiment, the container 4 comprises at least one protrusion 40, which preferably projects from the first and/or second wall 4a, 4b towards the outside of the container 4.

With reference to FIGS. 1, 3 and 5, at least one protrusion 40 that projects from the second wall 4b is shown.

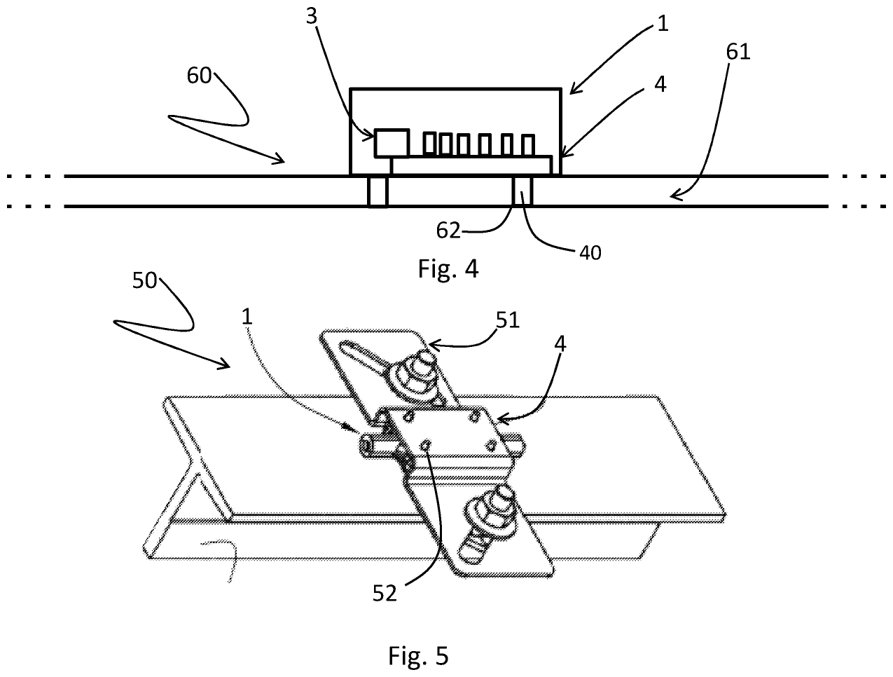

According to an embodiment shown in FIG. 4, the protrusions 40 project from the first wall 4a.

According to another invention comprised within the scope of the present invention, in FIG. 5 reference numeral 50 represents a system for clamping sensors for structural elements, comprising a sensor device 1 having at least one of the previously described features, and a clamping bracket 51 comprising at least one hole 52 that is designed to receive at least one of said protrusions 40 of the sensor device 1 by means of interference-type engagement.

This embodiment is particularly effective when there is a need to secure the sensor device 1 to a beam, for example, as shown in FIG. 5. These application contexts are analyses of bays of bridges, lift tracks, etc.

Preferably, when the sensor device is box-shaped, four protrusions are provided near to the edges of the second wall 4b, which protrusions are designed to engage in corresponding holes 52 in the above-mentioned bracket 51 by means of interference-type engagement. More advantageously, the bracket is slightly preloaded such that it tends to push the sensor device 1 against the surface under examination of the structure under analysis by means of the first face 4a such that it effectively sticks thereto.

According to one embodiment that is also covered by the scope of the present invention and with reference to FIG. 4, reference numeral 60 represents an examination unit 60 for structural elements, comprising a sensor device 1 having at least one of the previously described features, and a flexible tape 61 having at least one hole 62 that is designed to receive at least one of said protrusions 40 by means of interference-type engagement.

The flexible tape 61 is advantageously made of polymeric material. In particular, the flexible tape 61 is made of polypropylene, polyethylene, copolymers thereof or similar polyolefins.

It is possible to design the flexible tape 61 on the basis of the desired lengths and thicknesses.

Non-restrictive examples of installing the above-mentioned sensor device 1 in the various embodiments described may be:
installing said sensor device on a bridge to be monitored in order to monitor any structural displacement/failure thereof. In this case, it is particularly advantageous to install the above-mentioned sensor device on lower portions of bays of the bridge so as not to interfere with the surfaces and spaces intended for the passage of the means. Furthermore, taking a bridge having a plurality of bays as an example, each bay having a typical length that is equal to approximately 30 m, it is possible to install a first sensor device having a length of approximately 28 m, for example, in the lower or side portion of a first bay, and a second sensor device that is operatively connected to the first sensor device by means of connection means, again having a length of approximately 28 m, for example, in the lower or side portion of the second bay, and iteratively repeating this operation for the entire length of the bridge.
installing said sensor device on a tunnel to be monitored in order to monitor any structural displacement/failure thereof. In this case, it is particularly advantageous to install the above-mentioned sensor device on upper portions of ashlars of the tunnel in directions that are parallel and transverse to the direction of extension of said tunnel.
installing said sensor device on a wall of a house to be monitored in order to monitor any structural displacement/failure thereof. In this case, it is particularly advantageous to install the above-mentioned sensor device on walls of the house, orienting the sensor device both in the vertical direction and the transverse direction with respect to the line of the building floor. This also makes it possible to detect rotations and/or the displacement and/or failure of a floor with respect to another (for example the lift shaft can also be used for rapid installation, without leaving any equipment on show or near where the occupants pass).
installing said sensor device on a portion of land to be monitored which is susceptible to potential landslides, in order to monitor the possible structural displacement/failure thereof. In this case, it is particularly advantageous to install the above-mentioned sensor device inside a hole made in the ground up to a depth that is equal to approximately 150-200 m, in order to be able to monitor any rotations and/or displacement of portions of land.

These installations can preferably be formed by securing the sensor device to the desired structural portions by means of fixing means such as resins and/or glues, studs, screws, rivets, etc.

In particular, the flexible tape is a part that can house portions of the above-mentioned fixing means very effectively due to its extension and toughness (even when through-holes are provided) combined with the plastic deformation and resistance thereof to chemical or aggressive agents.

According to one embodiment, the examination unit 60 comprises a plurality of examination devices 1, and the tape 61 comprises a cable that operatively connects at least two examination devices 1 in series.

The embodiments of the sensor device 1 will become easier to understand from the method steps listed below.

Method for producing a sensor device 1, comprising
providing a container 4 in a first open configuration, in which the inside thereof is accessible, the container which is preferably box-shaped having a first elastic modulus E1,
providing a processing device 11, comprising a support 12 on which a processing unit 11a is installed, at least one inclinometer 3 and/or one accelerometer 15 that is/are housed on the support 12 and operatively connected to the processing unit 11a, and
housing said processing device 11 inside said container 4 and securing it by means of a fixing element 12a that has a second elastic modulus E2 which is greater than or equal to said first elastic modulus E1.

Method for producing a sensor device 1 having at least one of the previously described features, comprising:
providing the container 4 in a first open configuration, in which the inside thereof is accessible,
securing the processing device 11 to a first wall 4a of the container 4 by means of said fixing element 12a, and
making an inlet hole 4a and an outlet hole 4f in a second wall 4b of the container 4, which second wall is preferably opposite the first wall 4a,
operatively connecting the first cable 5a to the processing unit 11a of the processing device 11, and
closing the container 4.

At this point, a hydrophobic filler material R is inserted by injecting it through the inlet hole 4a in the container 4 in order to fill said container, thereby forming a watertight container 4.

The applicant has shown that, by means of this method and the use of two-component thermosetting epoxy-based resins, as previously discussed, it is possible to produce sensor devices that are able to satisfy the requirements for IP68 certification.

1. Sensor device (1) for monitoring structural elements, comprising
a container (4), which is preferably box-shaped and has a first elastic modulus (E1),
a processing device (11), which is housed inside said container (4) and comprises
a processing unit (11a),
a support (12) on which said processing unit (11a) is installed,
at least one inclinometer (3) and/or one accelerometer (15), which is/are housed on said support (12) and operatively connected to said processing unit (11a),
said support (12) is secured to said container (4) by means of a fixing element (12a) having a second elastic modulus (E2) that is greater than or equal to said first elastic modulus (E1).

2. The sensor device (1) according to claim 1, wherein
said container (4) is made of thermoplastics material,
said fixing element (12a) is a thermosetting resin.

3. The sensor device (1) according to claim 1, wherein
said support (12) is a printed circuit board, and
said processing unit (11a) and said at least one inclinometer (3) and/or said accelerometer (15) are housed on an opposite side of said support (12) to said fixing element (12a).

4. The sensor device (1) according to claim 1, wherein
said container (4) comprises a seat (13) that is delimited by a bead (12b),
and wherein said fixing element (12a) is exclusively positioned inside said seat (13).

5. The sensor device (1) according to claim 1, further comprising
a first cable (5a) that is operatively connected to said processing unit (11a) and passes through said container (4) via a first hole (4c) formed in said container,
said container comprising an inlet hole (4e) and an outlet hole (4f) that are configured so as to allow
insertion by injection of a filler material (R), preferably a hydrophobic filler material, through said inlet hole (4e),
filling the container (4) with said filler material (R) and resultant discharge of the filler material out of said outlet hole (4f).

6. The sensor device (1) according to claim 5, wherein
said filler material (R) is a thermosetting resin.

7. The sensor device (1) according to claim 5, wherein
said inlet hole (4e) and said outlet hole (4f) are made in a same second wall (4b) of said container (4), which second wall is preferably opposite a first wall (4a) on which said support (12) is secured to said container (4).

8. The sensor device (1) according to claim 1, wherein
said container (4) comprises at least one protrusion (40), which preferably projects from said first and/or second wall (4a, 4b) towards the outside of said container (4).

9. A clamping system (50) for a sensor for structural elements, comprising
a sensor device (1) according to claim 8,
a clamping bracket (51), comprising at least one hole (52) configured to receive at least one of said protrusions (40) of said sensor device (1) by means of interference-type engagement.

10. An examination unit (60) for structural elements, comprising
a sensor device (1) according to claim 8,
a flexible tape (61) having at least one hole (62) that is designed to receive at least one of said protrusions (40) by means of interference-type engagement.

11. Method for producing a sensor device (1), comprising
providing a container (4) in a first open configuration, in which the inside thereof is accessible, said container (4) having a first elastic modulus (E1), wherein said container (4) is box-shaped,
providing a processing device (11), comprising a support (12) on which a processing unit (11a) is installed, at least one inclinometer (3) and/or one accelerometer (15) that is/are housed on said support (12) and operatively connected to said processing unit (11a), and
housing said processing device (11) inside said container (4) and securing it by a fixing element (12a) that has a second elastic modulus (E2) which is greater than or equal to said first elastic modulus (E1).
